(19) United States
(12) Patent Application Publication
(10) Pub. No.: US 2012/0073668 A1
(43) Pub. Date: Mar. 29, 2012

(54) BLADDER TYPE ACCUMULATOR

(75) Inventor: Roger Bold, Deeside (GB)

(73) Assignee: FAWCETT CHRISTIE HYDRAULICS LIMITED, Flintshire (GB)

(21) Appl. No.: 13/321,358

(22) PCT Filed: May 17, 2010
(86) PCT No.: PCT/GB2010/000984

§ 371 Date: Nov. 18, 2011

(30) Foreign Application Priority Data
May 18, 2009 (GB) 0908450.0

(51) Int. Cl. F16L 55/04

(52) U.S. Cl. 137/1; 138/30

(57) ABSTRACT

A bladder accumulator comprises a fluid port assembly, for communicating between a main housing of the accumulator and a connection arrangement of the accumulator. An isolation valve arrangement is located within the fluid port assembly and is moveable between an open position for normal operation of the bladder accumulator and a closed position for isolating the bladder accumulator from a hydraulic system, to which is it mounted, wherein, the valve arrangement is fixable in the open position.

### RELATED APPLICATIONS AND CLAIM OF PRIORITY

This patent document claims priority to International Patent Application Number PCT/GB2010/000984, filed on May 17, 2010, which in turn claims priority to Great Britain Patent Application Number 0908450.0, filed May 18, 2009.

### BACKGROUND

This invention relates to an accumulator, in particular an accumulator for a hydraulic system for storing fluid energy under pressure.

Most hydraulic systems require variable and intermittent flow rates. Energy in a hydraulic system can be saved by using an accumulator to accept pumped output when the demand of the system is low and to supplement pumped output when the demand of the system is high.

Most accumulator designs are based on the principle that gas is compressible and oil is nearly incompressible. If an inert gas, such as nitrogen, is contained under pressure in a vessel and hydraulic fluid is pumped into that vessel at a higher pressure of that of the nitrogen gas, the nitrogen gas will compress until the pressure of the nitrogen gas is the same as that of the fluid being pumped. This increase in gas pressure is proportional to the decrease in the volume occupied by the gas. If the fluid is then trapped in the vessel, for example by closure of a valve, the vessel now contains energy. This is because the hydraulic fluid in the vessel is stored under pressure against the compressibility of the nitrogen gas. Thus, if the fluid is released from the vessel, for example by opening of a valve, it will be forced quickly out of the vessel, under pressure, by the expanding gas.

Accumulator design usually demands some means of separating the gas from the hydraulic fluid in the vessel and this is generally done by using a rubber bag or bladder, fitted within the vessel, to store the gas.

As well as the energy saving function of accumulators, there are many other useful storage applications, such as quicker system response to demand, counterbalance of heavy moving weights and leakage compensation. Bladder accumulators, which have low inertia and friction, can also be used to solve problems of shock elimination, impact absorption, cavitation elimination and pulse smoothing. Accumulators, enable the transfer of pressure from one dissimilar fluid or gas to another, without contact.

Typically, bladder accumulators have a flanged or threaded fluid port opening, which serves to connect the accumulator to the hydraulic system. The fluid port opening houses a poppet valve, which prevents extrusion of the bladder before the hydraulic system is pressurised.

Bladder accumulators are sometimes used in applications where space is limited. One such application is in a compact hydraulic system in a sub-sea control module for a wellhead in sub-sea oil and gas production. The hydraulic systems of such sub-sea control modules must be located within a compact hyperbaric chamber. Therefore, there is a requirement for bladder accumulators, to have a limited size, in particular a limited height, in order to fit within compact hydraulic systems.

When hydraulic systems undergo pressure tests, the pressure within the system increases to above that for which a bladder accumulator is designed, which can damage the accumulator. There is also the possibility of the gas pressure exceeding the design pressure of the accumulator thereby creating a hazard. In order to overcome this, either an isolating valve has to be fitted in the hydraulic system so as to isolate the accumulator from the remainder of the hydraulic system, which can increase the height of the accumulator, or the accumulator is detached from the hydraulic system and the connection thread or flange for the accumulator has to be sealed. Both of these options add time and effort.

Accordingly, there is a requirement for a bladder accumulator which is compact and can withstand pressures at the fluid port, which are higher than the upper safe limit for the operating pressure for the accumulator.

### SUMMARY

In pursuit of this aim, a presently preferred embodiment of the present invention provides a bladder accumulator comprising a fluid port assembly, for communicating between a main housing of the accumulator and a connection arrangement of the accumulator, wherein an isolation valve arrangement is located within the fluid port assembly and is moveable between an open position for normal operation of the bladder accumulator and a closed position for isolating the bladder accumulator from a hydraulic system to which it is mounted, wherein the valve arrangement is fixable in the open position. The present invention enables easy isolation of the accumulator from the hydraulic system during high pressure testing procedures, by simply closing the valve arrangement. Incorporating the valve arrangement within the fluid port assembly, prevents an increase in the height of the accumulator. In addition, safe normal operating of the accumulator is ensured by fixing the valve arrangement in the open position. The connection arrangement may be for connecting the accumulator to a hydraulic system and may comprises, for example a flange or a threaded connection element.

To maintain the compactness of the accumulator, the valve arrangement may comprise a valve element located within a portion of the channel within the fluid port assembly which communicates between the housing and the connection arrangement. For example the valve arrangement may be a ball valve arrangement, in which case, the valve element may be a ball valve element, rotatably mounted within the portion of the channel, preferably an increased diameter portion of the channel, within the fluid port assembly. Other types of valve arrangements are known in the art, which might be used in place of a ball valve arrangement.

Where the connection arrangement comprises a flange, the portion of the channel, in which the valve element is located, may be defined by a stepped face of the channel and an upstanding collar formed on the flange and slideable within the channel. In this case, the valve element may abut the stepped face and the upstanding collar. This enables incorporation of the valve arrangement within the fluid port assembly without having to increase the length of the fluid port assembly.

The valve arrangement may be operable, preferably manually, via a knob arrangement and the knob arrangement may be fixable to the fluid port assembly so as to fix the valve arrangement in the open position. In particular, a spindle passes through a wall of the fluid port assembly and may be fixed in a predetermined rotational orientation to a knob of the knob arrangement at one end and fixed in a predetermined rotational orientation to the valve element at its other end.

The knob arrangement may be rotatable to move the valve arrangement between the open and the closed position. In this case, at least one hole may be formed in the knob arrangement which communicates with corresponding hole(s) which may be formed in the fluid port assembly when the valve arrangement is in the open position, wherein the knob arrangement may additionally comprise a fixing element for the or each hole fixable through the communicating holes to fix the valve arrangement in the open position.

The bladder accumulator may additionally comprise a poppet valve assembly at an end of the fluid port assembly which communicates with the housing. In this case, the isolation valve arrangement may be located between the poppet valve and the connection arrangement.

The present invention also provides a method of using a bladder accumulator of the type described above, comprising the steps of: fixing the bladder accumulator to a hydraulic system via the connection arrangement; isolating the bladder accumulator from the hydraulic system for high pressure testing of the hydraulic system by moving the valve arrangement to the closed position; and fixing the valve arrangement in the open position during normal operation of the hydraulic system.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 shows a longitudinal cross-section of a bladder accumulator according to the present invention;

FIG. 2 shows schematically the components making up the isolation valve arrangement of the bladder accumulator of FIG. 1;

FIG. 3 shows a view of a knob of the isolation valve arrangement of FIG. 2, from the outside of the bladder accumulator; and

FIG. 4 shows a view of the opposite side of the knob to that shown in FIG. 3.

### DETAILED DESCRIPTION

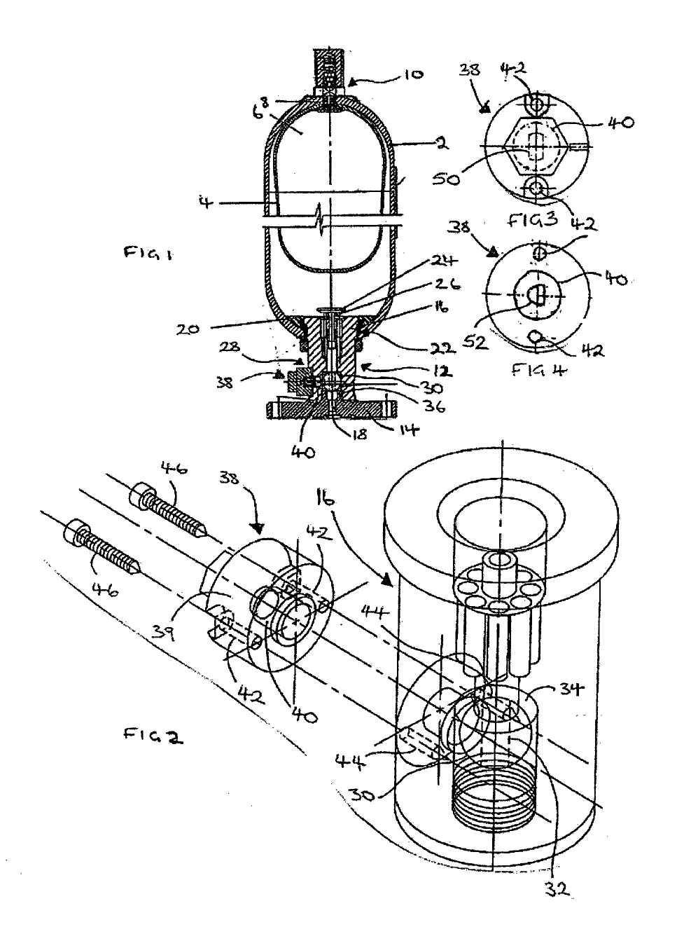

A preferred embodiment of the present invention will now be described with particular reference FIGS. 1 and 2.

The bladder accumulator of FIG. 1 comprises a housing (2), within which is located a bladder (4) filled with an inert gas (6), such as nitrogen. The upper end of the housing (2) and the upper end of the bladder (4) are formed with openings (8), into which is fitted a charging assembly (10), via which the gas (6) can be introduced into the bladder at the required pressure.

The housing (2) of the bladder accumulator has an opening at its lower end to which is fitted a fluid port assembly (12). The bladder accumulator is connectable to a hydraulic system via a connection arrangement, which in this example is a flange (14). The flange (14) is fitted to the end of the fluid port assembly (12) remote from the housing (2). The connection arrangement between the accumulator and the hydraulic system may alternatively comprise a threaded connection element formed in the end of the fluid port assembly (12) remote from the housing (2). In this case, the fluid port assembly (12) of the accumulator may be directly connectable to the hydraulic system via the threaded connection element.

The fluid port assembly (12) comprises a fluid port body (16) which extends from within the housing (2) to the flange (14) and comprises a central channel which communicates between housing (2) and the hydraulic system, via a central opening (18) in the flange (14).

An anti-extrusion ring (20) is fitted around the upper end of the fluid port body (16), within the lower end of the housing (2) and the fluid port body is fixed with respect to the anti-extrusion ring (20) and the housing (2) via a connection arrangement (22), which also seals between the fluid port body and the anti-extrusion ring and the housing (2). The upper end of the channel through the fluid port body (16) is closed off by a poppet valve arrangement, comprising a poppet valve (24) and spring (26).

An isolation valve arrangement, comprising ball valve arrangement (28), shown in more detail in FIG. 2, is located within the fluid port body (16) between the poppet valve arrangement (24, 26) and the flange (14). The ball valve arrangement comprises a spherical ball valve element (30) formed with a channel (32) passing through it. The ball valve element (30) is rotatably housed within an increased diameter portion of the channel through the fluid port body (16), with an upper part of the ball valve element abutting a shoulder (34) formed by a stepped increase in the diameter of the channel towards the lower end of the channel through the fluid port body (16).

The flange (14) is formed with a central annular collar (36) upstanding from the upper surface of the flange and surrounding the central channel (18) of the flange. The central collar (36) has an external diameter that fits slideably within the lower end of the channel formed within the fluid port body (16). With the central collar (36) of the flange (14) fitted within the lower end of the channel in the fluid port body (16) the upper end of the collar abuts a lower part of the ball valve element (30). Thus, the ball valve element (30) is rotatably mounted within the channel formed in the fluid port body (16) between the stepped face (34) of the channel and the upper end of the central collar (36) of the flange (14). The ball valve element is rotatable within the fluid port body (16), between an open position of the ball valve arrangement (28), shown in FIGS. 1 and 2, in which the channel (32) of the ball valve element (30) is aligned and communicates with the channels in the fluid port body (16) and the flange (14), and a closed position of the ball valve arrangement, in which the channel (32) of the ball valve element (30) is substantially perpendicular to and does not communicate with the channels in the fluid port body (16) and flange (14).

The ball valve element (32) is rotated via a knob arrangement (38), comprising a knob (39) fixed to a spindle (40). The spindle (40) is fixed within a first recess formed in the side of the knob (39) facing the fluid port assembly (12) in FIG. 1. The spindle (40) is rotatably fixed with respect to the knob (39) by virtue of a key (50) upstanding from an end surface of the spindle, which key fits within a correspondingly shaped recess formed in the base of the first recess of the knob (39) into which the spindle is fixed. The fitment of the key (50) of the spindle (40) in the corresponding recess ensures that the spindle can be fitted to the knob in only two relative orientations, each 180° apart from each other. FIG. 3 shows the knob arrangement (38) from the outside of the bladder accumulator of FIG. 1 (i.e. it shows the side of the knob facing away from the fluid port assembly (12) in FIG. 1), with the spindle (40) and key (50) shown in dotted lines because the spindle with the upstanding key is fitted into the first recess in the knob (39) from the opposite side of the knob to that shown in FIG. 3.

The spindle (40) is rotatably mounted within a channel passing between the outside of the fluid port body (16) and the portion of the channel in the fluid port body where the ball valve element (30) is located, with the end of the spindle (40) remote from the knob arrangement (38) fixed to the ball valve element (30). FIG. 4 shows the side of the knob (39) facing the fluid port assembly (12), with the spindle (40) upstanding from the knob. The end of the spindle (40) remote from the knob (39) is formed with an upstanding crescent shaped key (52) on its end surface. The key (52), fits within a correspondingly shaped recess in the ball valve element (30), so that the end of the spindle (40) remote from the knob can fit to the ball valve element (30) in one relative rotational orientation only, rotatably fixing the spindle (40) with respect to the ball valve element (30). Thus, rotation of the knob (39) rotates the ball valve element (30) via the spindle (40) to move the ball valve arrangement (28) between open and closed positions.

The knob (39) is formed with two screw holes (42), which extend in substantially the same direction as the spindle (40) from an outer surface to an inner surface of the knob. When the ball valve arrangement (28) is in an open position, the two screw holes (42) in the knob (39) are aligned with two screw holes (44) formed in the outer surface of the fluid port body (16). This alignment is ensured by the fixed relative rotational orientation between the knob (39) and the spindle (40) due to key (50) and between the spindle (40) and the ball valve element (30) due to key (52). Thus, the ball valve arrangement (28) can be fixed in the open position by fixing a pair of screw elements (46) within the aligned screw holes (42, 44).

The bladder accumulator of FIG. 1 is fixed to a hydraulic system via the flange (14). Hydraulic fluid from the hydraulic system can pass into the bladder accumulator via the channels in the flange (14) and the fluid port assembly (12), when the ball valve arrangement is in the open position. When the hydraulic system is tested to a pressure higher than that which the bladder accumulator can safely withstand, the ball valve arrangement (28) is simply moved to the closed position by rotating the knob arrangement (38) so as to prevent hydraulic fluid passing from the hydraulic system into the housing (2) of the bladder accumulator. Because the ball valve arrangement (28) is housed within the fluid port assembly, the height of the bladder accumulator is not increased. After testing and during normal operation of the bladder accumulator the ball valve arrangement (28) is fixed in the open position by rotating the knob (38) to align the screw holes (42, 44) and fixing the screws (46) into the aligned screw holes (42, 44).

1. A bladder accumulator comprising a fluid port assembly, for communicating between a main housing of the accumulator and a connection arrangement of the accumulator, wherein an isolation valve arrangement is located within the fluid port assembly and is moveable between an open position for normal operation of the bladder accumulator and a closed position for isolating the bladder accumulator from a hydraulic system to which it is mounted, wherein the valve arrangement is fixable in the open position.

2. A bladder accumulator according to claim 1, wherein the valve arrangement comprises a valve element located within a portion of the channel within the fluid port assembly which communicates between the housing and the connection arrangement.

3. A bladder accumulator according to claim 2, wherein the valve element comprises a ball valve element, rotatably mounted within the portion of the channel within the fluid port assembly.

4. A bladder accumulator according to claim 2, wherein the connection arrangement comprises a flange, and the portion of the channel is defined by a stepped face of the channel and an upstanding collar formed on the flange and slideable within the channel.

5. A bladder accumulator according to claim 4, wherein the valve element abuts the stepped face and abuts the upstanding collar.

6. A bladder accumulator according to claim 2, wherein the valve arrangement is operable via a knob arrangement and the knob arrangement is fixable to the fluid port assembly so as to fix the valve arrangement in the open position.

7. A bladder accumulator according to claim 6, wherein a spindle passes through a wall of the fluid port assembly and is fixed in a predetermined rotational orientation to a knob of the knob arrangement at a first end and to the valve element at a second end.

8. A bladder accumulator according to claim 6, wherein the knob arrangement is rotatable to move the valve arrangement between the open and the closed position.

9. A bladder accumulator according to claim 8, wherein at least one hole is formed in the knob arrangement which communicates with at least one corresponding hole in the fluid port assembly when the valve arrangement is in the open position, wherein the knob arrangement additionally comprises a fixing element for the at least one hole fixable through the at least one communicating hole to fix the valve arrangement in the open position.

10. A bladder accumulator according to claim 1, additionally comprising a poppet valve assembly at an end of the fluid port assembly which communicates with the housing.

11. A bladder accumulator according to claim 10, wherein the isolation valve arrangement is located between the poppet valve and the connection arrangement.

12. A bladder accumulator according claim 1, wherein the connection arrangement comprises a flange.

13. A method of using a bladder accumulator comprising:
fixing the bladder accumulator to a hydraulic system via the connection arrangement;
isolating the bladder accumulator from the hydraulic system for high pressure testing of the hydraulic system by moving the isolation valve arrangement to the closed position; and
fixing the valve arrangement in the open position during normal operation of the hydraulic system.
